(19) United States
(12) Patent Application Publication
(10) Pub. No.: US 2015/0102786 A1
(43) Pub. Date: Apr. 16, 2015

(54) PFC CONTROL CIRCUIT, ACTIVE PFC CIRCUIT AND PFC CONTROL METHOD

(71) Applicants: Samsung Electro-Mechanics Co., Ltd., Suwon (KR); University of Seoul Industry Cooperation Foundation, Seoul (KR)

(72) Inventors: Byung Hoon KIM, Suwon (KR); Jeong Mo YANG, Suwon (KR); Hwan CHO, Suwon (KR); Yong Seong ROH, Incheon (KR); Young Jin MOON, Gwangju (KR); Jeong Pyo PARK, Gwangmyeong (KR); Chang Sik YOO, Seoul (KR); Yu Jin JANG, Suwon (KR); Joong Ho CHOI, Seongnam (KR)

(73) Assignees: Samsung Electro-Mechanics Co., Ltd., Suwon (KR); University of Seoul Industry Cooperation Foundation, Seoul (KR)

(21) Appl. No.: 14/515,122

(22) Filed: Oct. 15, 2014

(30) Foreign Application Priority Data
Oct. 16, 2013 (KR) 10-2013-0123440

(51) Int. Cl. H02M 1/42

(52) U.S. Cl. CPC H02M 1/4208
USPC 323/208

(57) ABSTRACT

The present invention relates to a PFC control circuit, an active PFC circuit, and a PFC control method. According to an embodiment of the present invention, a PFC control circuit including: an inductor current sensing unit for sensing an inductor current of a PFC circuit; an output voltage feedback unit for outputting a feedback output signal; a sensing and feedback signal application unit for outputting a sensing voltage signal during switching duty on of the PFC circuit and adding the feedback output signal to the sensing voltage signal to output the added signal during switching duty off of the PFC circuit; and a PFC control unit for generating a comparison signal and generating a duty control signal from the comparison signal and a first reference signal to make variations due to an internal offset be removed or reduced is provided.

### CROSS-REFERENCE TO RELATED APPLICATIONS

Claim and incorporate by reference domestic priority application and foreign priority application as follows:

“CROSS REFERENCE TO RELATED APPLICATION This application claims the benefit under 35 U.S.C. Section 119 of Korean Patent Application Serial No. 10-2013-0123440, filed Oct. 16, 2013, which is hereby incorporated by reference in its entirety into this application.”

### BACKGROUND OF THE INVENTION

1. Field of the Invention

The present invention relates to a PFC control circuit, an active PFC circuit, and a PFC control method, and more particularly, to a PFC control circuit with improved input offset, an active PFC circuit, and a PFC control method.

2. Description of the Related Art

In recent times, power consumption is increasing with the increased use of electronic device in various fields. At this time, it is needed to suppress a harmonic component generated from an input terminal of the electronic device in order to minimize inefficient influence in an input power line of the electronic device and interference with the external electronic device. To this end, use of a power factor correction (PFC) circuit is essential. Since a passive PFC circuit consisting of an inductor and a capacitor has a very large form factor and a low power factor, use of the passive PFC circuit is limited, and currently, an active PFC circuit using a switching converter has been mainly used. The active PFC circuits are classified into continuous conduction mode (CCM), critical conduction mode (CRM), and discontinuous conduction mode (DCM) according to the waveform of an inductor current. The CCM PFC, a method of operating an inductor current most similarly to the shape of an input voltage which is applied from driving AC power and rectified through a diode bridge, is used when a load is large. The CRM PFC, which detects a zero current of an inductor using a current sensing device, has a high variable efficiency, but inefficient loss of the inductor is large. The DCM PFC is a PFC driving method suitable for a light load operation while constantly maintaining an operating frequency of the inductor current. The same PFC circuit may be used in parallel or the different operation modes may be combined according to the load condition to be driven.

In a conventional active PFC circuit consisting of an inductor, a power switch, and a diode, the RMS of an input current in an internal current loop operates in a sinusoidal form like an AC input voltage. A PWM duty cycle of an input voltage line is controlled through the internal loop to be equal to the input current. The CCM method means that the average input current sensed from current sensing operates in the same form according to the input voltage of the device.

At this time, in the conventional active PFC circuit, degradation of power factor and over voltage protection (OVP) characteristics occurs due to an input offset of an operational transconductance amplifier (OTA) in an IC. Referring to FIG. 5, as shown, the problems may be caused in a light load when the input offset of the OTA in the IC is large.

### SUMMARY OF THE INVENTION

The present invention has been invented in order to overcome the above-described problems and it is, therefore, an object of the present invention to provide a technology for improving a power factor during a PFC operation of a PFC circuit. For example, it is an object of the present invention to improve a power factor and OVP characteristics by implementing a circuit for minimizing OTA input offset variations in an IC.

In accordance with a first aspect of the present invention to achieve the object, there is provided a PFC control circuit including: an inductor current sensing unit for sensing an inductor current of a PFC circuit; an output voltage feedback unit for outputting a feedback output signal by feeding back an output voltage sensed from an output of the PFC circuit; a sensing and feedback signal application unit for outputting a sensing voltage signal sensed by the inductor current sensing unit during switching duty on of the PFC circuit and outputting a signal obtained by adding the feedback output signal to the sensing voltage signal during switching duty off of the PFC circuit; and a PFC control unit for generating a comparison signal from an output of the sensing and feedback signal application unit and generating and outputting a duty control signal for controlling a switching duty from the comparison signal and a first reference signal to make variations due to an internal offset be removed or reduced.

At this time, in an example, the sensing and feedback signal application unit may include a summing switch turned on during the switching duty off to add the feedback output signal to the sensing voltage signal; and a filter for receiving the sensing voltage signal or a summing signal, which is obtained by adding the feedback output signal to the sensing voltage signal, and filtering the received signal to output the filtered signal.

Further, in an example, the output voltage feedback unit may include a feedback voltage amplification unit for receiving the output voltage, which is sensed from the output of the PFC circuit and fed back, and a second reference signal to compare and amplify the received voltage and signal; and a voltage-current conversion unit for receiving an output of the feedback voltage amplification unit and performing voltage-current conversion to output the feedback output signal.

In another example, the PFC control unit may include a comparison signal generation unit for receiving the output signal of the sensing and feedback signal application unit and outputting the comparison signal by removing or reducing the internal offset; and a comparison unit for receiving the comparison signal and comparing the comparison signal with the first reference signal to generate the duty control signal for controlling a duty of a power switch.

At this time, in an example, the comparison signal generation unit may include an OTA for receiving the output signal of the sensing and feedback signal application unit and outputting the comparison signal in which the input offset generated inside is removed or reduced; and an offset removal unit connected to the OTA to remove or reduce the input offset.

Further, at this time, in an example, a positive input terminal of the OTA may receive the output signal of the sensing and feedback signal application unit, and the offset removal unit may be connected to a negative input terminal of the OTA to provide a ground signal to the negative input terminal during the switching duty on and input a third reference signal to the negative input terminal during the switching duty off.

At this time, in another example, the third reference signal input to the negative input terminal may be set to the maximum value of the possible input offset.

Further, according to an example, the PFC circuit may be a CCM-operated active PFC circuit.

Next, in accordance with a second aspect of the present invention to achieve the object, there is provided an active PFC circuit including: an inductor for receiving input power to transfer energy; a power switch connected to a rear end of the inductor to transfer the energy from the inductor to an output terminal during a switching off operation and block the transfer of the energy to the output terminal during a switching on operation according to a duty control signal; a diode connected to the rear end of the inductor in parallel to the power switch to transfer the energy to the output terminal and block a backflow of the energy from the output terminal during the switching on operation of the power switch; an output capacitor connected to the output terminal, which is a rear end of the diode, in parallel to a load to charge some of the energy transferred through the diode and output the charged energy to the load during the on operation of the power switch; and a PFC control circuit according to an example of the above-described first aspect of the present invention, which generates the duty control signal by receiving an inductor current flowing in the inductor and a signal sensed from an output to the load.

At this time, in an example, a PFC control unit of the PFC control circuit may include a comparison signal generation unit for receiving an output signal of a sensing and feedback signal application unit and outputting a comparison signal by removing or reducing an internal offset; and a comparison unit for generating the duty control signal for controlling a duty of the power switch by receiving the comparison signal and comparing the comparison signal with a first reference signal.

Further, at this time, in another example, the comparison signal generation unit may include an OTA for receiving the output signal of the sensing and feedback signal application unit and outputting the comparison signal in which the input offset generated inside is removed or reduced; and an offset removal unit connected to the OTA to remove or reduce the input offset. At this time, a positive input terminal of the OTA may receive the output signal of the sensing and feedback signal application unit and the offset removal unit may be connected to a negative input terminal of the OTA to provide a ground signal to the negative input terminal during switching duty on and input a third reference signal to the negative input terminal during switching duty off.

In addition, at this time, in another example, the third reference signal input to the negative input terminal may be set to the maximum value of the possible input offset.

Further, in an example, the active PFC circuit may perform a CCM operation.

Next, in accordance with a third aspect of the present invention to achieve the object, there is provided a PFC control method including: an inductor current sensing step of sensing an inductor current of a PFC circuit; an output voltage feedback step of outputting a feedback output signal by feeding back an output voltage sensed from an output of the PFC circuit; a sensing and feedback signal application step of outputting a sensing voltage signal sensed in the inductor current sensing step during switching duty on of the PFC circuit and outputting a signal obtained by adding the feedback output signal to the sensing voltage signal during switching duty off of the PFC circuit; and a duty control step of generating a comparison signal from an output in the sensing and feedback signal application step and generating and outputting a duty control signal for controlling a switching duty from the comparison signal and a first reference signal to make variations due to an internal offset be removed or reduced.

At this time, in an example, the sensing and feedback signal application step may include a step of adding the feedback output signal to the sensing voltage signal by turning on a summing switch during the switching duty off; and a filtering step of filtering the sensing voltage signal during the switching duty on and filtering a summing signal, which is obtained by adding the feedback output signal to the sensing voltage signal, to output the filtered signal during the switching duty off.

Further, in an example, the output voltage feedback step may include a feedback voltage amplification step of receiving an output voltage, which is sensed from the output of the PFC circuit and fed back, and a second reference signal to compare and amplify the received voltage and signal; and a conversion step of receiving an output of the feedback voltage amplification step and performing voltage-current conversion to output the feedback output signal.

In another example, the duty control step may include a comparison signal generation step of receiving the output signal of the sensing and feedback signal application step and outputting the comparison signal by removing or reducing the internal offset; and a control signal generation step of generating the duty control signal for controlling a duty of a power switch by receiving an output of the comparison signal generation step and comparing the received output with the first reference signal.

At this time, in an example, in the comparison signal generation step, the signal applied from the sensing and feedback signal application step may be input to a positive input terminal of an OTA, ground power may be input to a negative input terminal of the OTA during the switching duty on, a third reference signal may be input to the negative input terminal of the OTA during the switching duty off, and the OTA may output the comparison signal by removing or reducing the internal input offset.

Further, at this time, in another example, the third reference signal input to the negative input terminal may be set to the maximum value of the possible input offset.

Further, according to an example, the PFC circuit may be a CCM-operated active PFC circuit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram schematically showing a PFC control circuit in accordance with an embodiment of the present invention;

FIG. 2 is a block diagram schematically showing a PFC control circuit in accordance with another embodiment of the present invention;

FIG. 3 is a circuit diagram schematically showing an active PFC circuit including a PFC control circuit in accordance with an embodiment of the present invention;

FIG. 4 is a graph schematically showing a CCM operation waveform of an active PFC circuit having a PFC control circuit in accordance with an embodiment of the present invention;

FIG. 5 is a graph schematically showing a light load regulation waveform in an active PFC circuit having a conventional PFC control circuit;

FIG. 6 is a flowchart schematically showing a PFC control method in accordance with another embodiment of the present invention; and

FIG. 7 is a flowchart schematically showing a PFC control method in accordance with another embodiment of the present invention.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

In this specification, when an element is referred to as being “connected or coupled to” or “disposed in” another element, it can be “directly” connected or coupled to or “directly” disposed in the other element or connected or coupled to or disposed in the other element with another element interposed therebetween, unless it is referred to as being “directly coupled or connected to” or “directly disposed in” the other element.

Although the singular form is used in this specification, it should be noted that the singular form can be used as the concept representing the plural form unless being contradictory to the concept of the invention or clearly interpreted otherwise. It should be understood that the terms such as “having”, “including”, and “comprising” used herein do not preclude existence or addition of one or more other elements or combination thereof.

PFC Control Circuit

A PFC control circuit in accordance with a first aspect of the present invention will be described in detail with reference to the drawings. At this time, the reference numeral that is not mentioned in the reference drawing may be the reference numeral that represents the same element in another drawing.

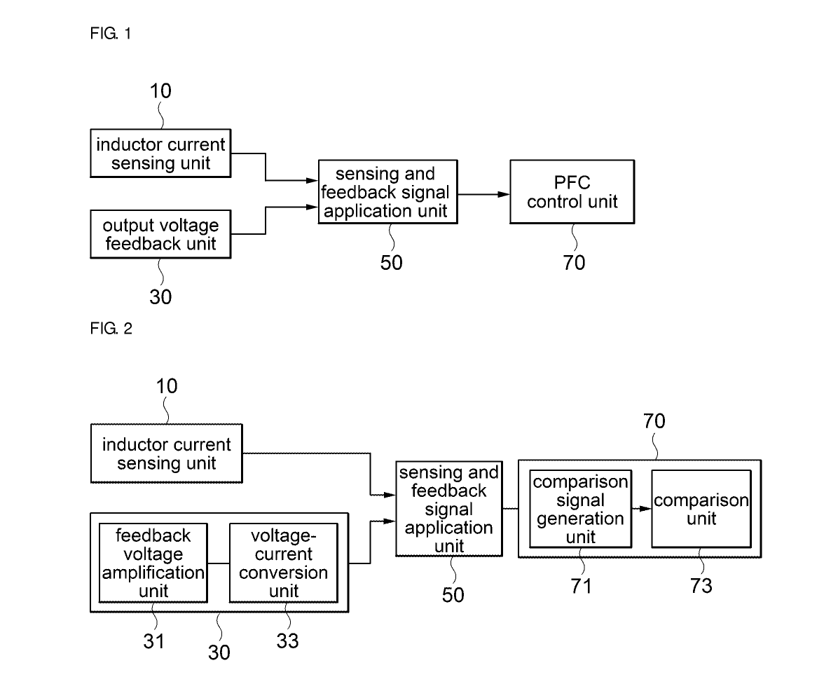

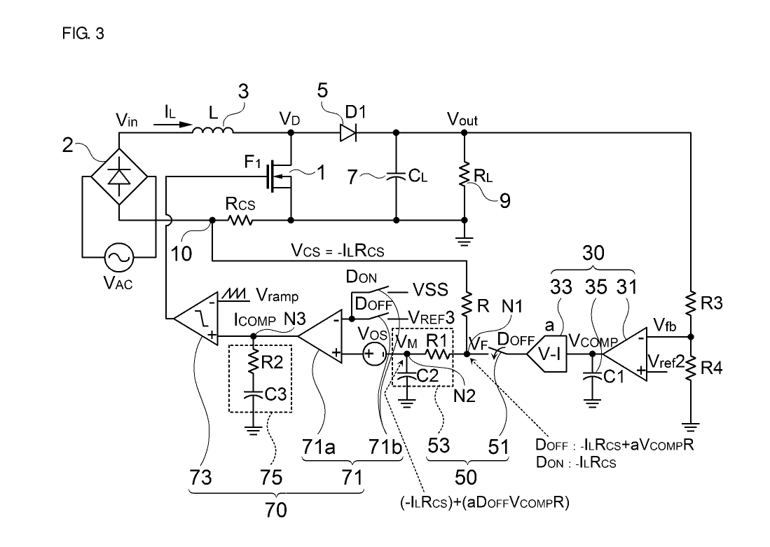

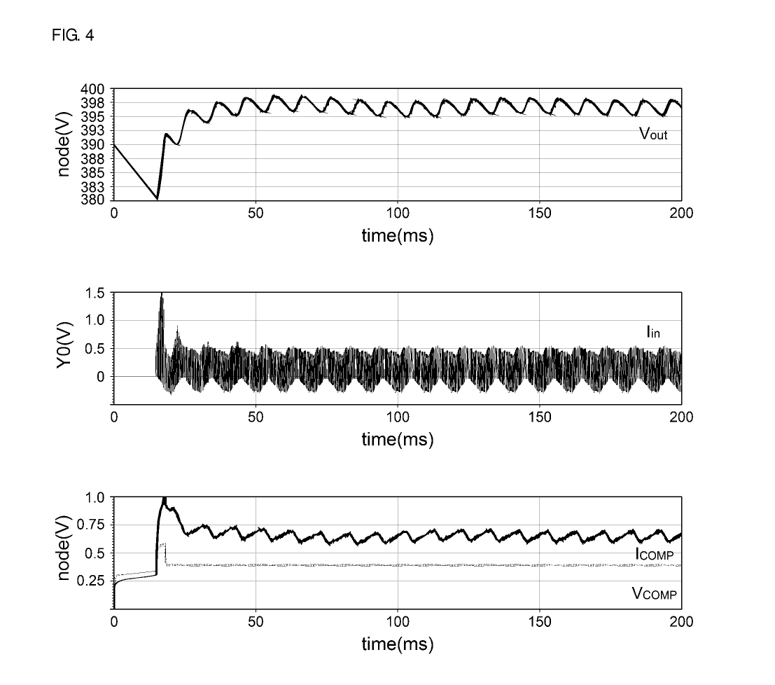

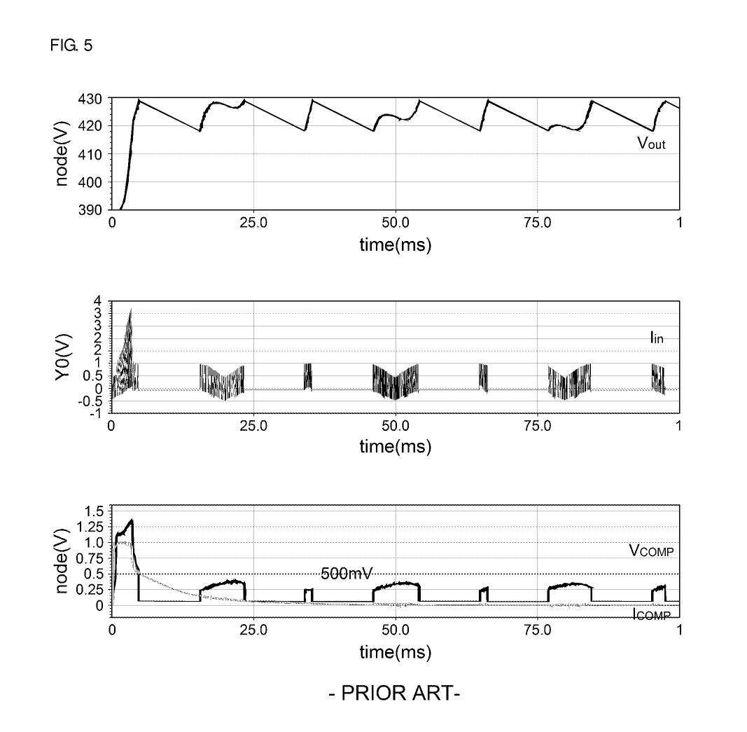

FIG. 1 is a block diagram schematically showing a PFC control circuit in accordance with an embodiment of the present invention, FIG. 2 is a block diagram schematically showing a PFC control circuit in accordance with another embodiment of the present invention, FIG. 3 is a circuit diagram schematically showing an active PFC circuit including a PFC control circuit in accordance with an embodiment of the present invention, and FIG. 4 is a graph schematically showing a CCM operation waveform of an active PFC circuit having a PFC control circuit in accordance with an embodiment of the present invention.

Referring to FIGS. 1, 2, and/or 3, a PFC control circuit according to an example may include an inductor current sensing unit 10, an output voltage feedback unit 30, a sensing and feedback signal application unit 50, and a PFC control unit 70. For example, in an example, a PFC circuit to which the PFC control circuit is applied may be a current conduction mode (CCM)-operated active PFC circuit.

At this time, each element will be described in detail with reference to FIGS. 1, 2, and/or 3.

First, referring to FIGS. 1, 2, and/or 3, the inductor current sensing unit 10 senses an inductor current of a PFC circuit. For example, referring to FIG. 3, the inductor current sensing unit 10 senses the inductor current through a sensing resistor Rcs connected to a ground in parallel to a power switch 1 of the PFC circuit. At this time, the inductor current I_{L} is sensed through the sensing resistor Rcs. For example, the inductor current I_{L} is sensed through a sensing voltage Vcs=−I_{L}Rcs sensed through the sensing resistor Rcs. At this time, the inductor current I_{L} flows through the sensing resistor Rcs through an inductor 3 and the power switch 1 when the power switch 1 F1 is turned on, and the inductor current I_{L}, which is obtained by adding the current generated by energy accumulated in the inductor 3 during the previous turn-on of the power switch 1 to the current applied to the inductor 3 by input power Vin, flows through the sensing resistor Rcs when the power switch 1 is turned off.

Next, the output voltage feedback unit 30 of the PFC control circuit will be described in detail with reference to FIGS. 1, 2, and/or 3. The output voltage feedback unit 30 outputs a feedback output signal by feeding back an output voltage sensed from an output of the PFC circuit.

For example, referring to FIGS. 2 and/or 3, the output voltage feedback unit 30 may include a feedback voltage amplification unit 31 and a voltage-current conversion unit 33. At this time, referring to FIG. 3, the feedback voltage amplification unit 31 may receive the output voltage V_{fb}, which is sensed from the output of the PFC circuit and fed back, and a second reference signal V_{ref2} to compare and amplify them. The fed-back output voltage V_{fb} is a voltage which is divided by output voltage division resistors R3 and R4 and sensed, and the second reference signal V_{ref2} is a signal for comparison with the output voltage V_{fb} sensed from the output of the PFC circuit. Further, the voltage-current conversion unit 33 receives an output of the feedback voltage amplification unit 31 and performs voltage-current conversion to output as the feedback output signal. Referring to FIG. 3, the voltage-current conversion unit 33 converts the output of the feedback voltage amplification unit 31 to the feedback output signal as a current signal to add the signal output from the output voltage feedback unit 30 to the signal output from the inductor current sensing unit 10 through a summing switch 51 during switching duty off. Even though it is expected that the PFC output is a stable DC voltage, the actual output may exhibit DC+AC characteristics due to PFC characteristics. At this time, a frequency of an AC component is twice a frequency of an input voltage VAC. In order to filter this AC component, a first bandwidth control filter 35 may be provided to set a bandwidth of the output voltage feedback unit 30 very low. The first bandwidth control filter 35 may be connected between the feedback voltage amplification unit 31 and the voltage-current conversion unit 33. For example, referring to FIG. 3, the first bandwidth control filter 35 may be a capacitor C1 having one end connected to a rear end of the feedback voltage amplification unit 31 and the other end connected to the ground.

Next, the sensing and feedback signal application unit 50 will be described in detail with reference to FIGS. 1, 2, and/or 3. The sensing and feedback signal application unit 50 outputs a sensing voltage signal or a summing signal from the sensing voltage signal in the inductor current sensing unit 10 and the output of the output voltage feedback unit 30. The sensing and feedback signal application unit 50 outputs the sensing voltage signal or the summing signal according to switching of the PFC circuit. First, the sensing and feedback signal application unit 50 outputs the sensing voltage signal Vcs sensed by the inductor current sensing unit 10 during the switching duty on D_{ON} of the PFC circuit. Further, the sensing and feedback signal application unit 50 outputs the summing signal by adding the feedback output signal of the output voltage feedback unit 30 to the sensing voltage signal sensed by the inductor current sensing unit 10 during the switching duty off D_{OFF} of the PFC circuit. Referring to FIGS. 2 and/or 3, in an example, the feedback output signal may be obtained from the current signal obtained by amplifying the sensed feedback output voltage V_{fb} through the feedback voltage amplification unit 31 and converting the amplified signal through the voltage-current conversion unit 33.

For example, the sensing voltage signal in the inductor current sensing unit 10 and the feedback output signal of the output voltage feedback unit 30 will be described with reference to FIG. 3. The sensing voltage signal Vcs is sensed by the inductor current sensing unit 10. At this time, since the current input to a bridge diode 2 is equal to the current output from the bridge diode 2, the inductor current sensing unit 10 can sense the current I_{L} flowing through the inductor 3. Since the inductor current I_{L} flows through the sensing resistor Rcs, the inductor current sensing unit 10 can sense the inductor current I_{L} flowing through the sensing resistor Rcs by sensing the sensing voltage signal Vcs regardless of the switching of the PFC circuit. That is, the sensing voltage signal Vcs sensed by the inductor current sensing unit 10 is −I_{L}Rcs. Meanwhile, during the switching duty off D_{OFF} of the PFC circuit, the output voltage feedback unit 30 may output a current value proportional to an output voltage V_{COMP} of the feedback voltage amplification unit 31 from the voltage-current conversion unit 33. At this time, during the switching duty off of the PFC circuit, the summing switch 51 of the sensing and feedback signal application unit 50 is turned on and the feedback output signal can be obtained from the current value proportional to the output voltage V_{COMP} of the feedback voltage amplification unit 31. The feedback output signal generated during the switching duty off of the PFC circuit is added to the sensing voltage signal sensed by the inductor current sensing unit 10.

For a concrete example with reference to FIG. 3, the sensing and feedback signal application unit 50 may include the summing switch 51 and a filter 53. The summing switch 51 is turned off during the switching duty on D_{ON} of the PFC circuit and turned on during the switching duty off D_{OFF} of the PFC circuit to generate the summing signal by adding the feedback output signal of the output voltage feedback unit 30 to the sensing voltage signal Vcs sensed by the inductor current sensing unit 10. Since the summing switch 51 is turned off during the switching duty on D_{ON}, the sensing voltage signal sensed by the inductor current sensing unit 10 is output. For example, in FIG. 3, during the switching duty on D_{ON} of the PFC circuit, since the summing switch 51 is turned off and a current doesn't flow through a resistor R between a summing node N1 on a rear end of the summing switch 51 and the inductor current sensing unit 10, a node voltage V_{F} in the summing node N1 on the rear end of the summing switch 51 is equal to the sensing voltage signal Vcs. That is, during the switching duty on of the PFC circuit, the node voltage V_{F} is −I_{L}Rcs.

Further, in FIG. 3, during the switching duty off D_{OFF} of the PFC circuit, the summing switch 51 of the sensing and feedback signal application unit 50 is turned on to generate the summing signal by adding the feedback output signal of the feedback unit 30 to the sensing voltage signal Vcs. Specifically, the voltage-current conversion unit 33 of the output voltage feedback unit 30 may output a current value aV_{COMP} proportional to the output voltage V_{COMP} of the feedback voltage amplification unit 31. Here, a is a proportional conversion factor of the voltage-current conversion unit 33. At this time, the output current signal aV_{COMP} of the voltage-current conversion unit 33 flows to the inductor current sensing unit 10 through the resistor R between the summing node N1 and the inductor current sensing unit 10. The feedback output signal has a voltage value aV_{COMP}R by the output current signal aV_{COMP} of the voltage-current conversion unit 33 flowing through the resistor R. At this time, the node voltage V_{F} in the summing node N1 on the rear node of the summing switch 51 is a voltage obtained by adding the feedback output voltage aV_{COMP}R to the sensing voltage signal Vcs. That is, the node voltage V_{F} is −I_{L}Rcs+aV_{COMP}R.

Further, referring to FIG. 3, the filter 53 of the sensing and feedback signal application unit 50 is connected to a rear end of the summing node N1. The filter 53 of the sensing and feedback signal application unit 50 receives the sensing voltage signal Vcs or the summing signal obtained by adding the feedback output signal to the sensing voltage signal and filters the received signal to output the filtered signal. For example, referring to FIG. 3, the filter 53 receives the sensing voltage signal Vcs=−I_{L}Rcs in the inductor current sensing unit 10 when the summing switch 51 is turned off during the switching duty on D_{ON} of the PFC circuit and receives the summing signal −I_{L}Rcs+aV_{COMP}R obtained by adding the feedback output signal aV_{COMP}R to the sensing voltage signal Vcs in the inductor current sensing unit 10 and filters the received signal to output the filtered signal when the summing switch 51 is turned on during the switching duty off D_{OFF}. For example, the filter 53 may be an RC filter. Referring to FIG. 3, for example, the filter 53 may be an RC filter consisting of a resistor R1 connected to the rear end of the summing node N1 and a capacitor C2 connected between a rear end of the resistor R1 and the ground. At this time, a cycle average voltage V_{M} in a top node N2 of the capacitor C2 may −I_{L}Rcs+D_{off}R(aV_{COMP}). That is, V_{M}=−I_{L}Rcs+aD_{off}V_{COMP}R.

Next, the PFC control unit 70 of the PFC control circuit will be described in detail with reference to FIGS. 1, 2, and/or 3. The PFC control unit 70 generates a duty control signal to make variations due to an internal offset be removed or reduced. At this time, the PFC control unit 70 generates a comparison signal from the output of the sensing and feedback signal application unit 50 and generates the duty control signal for controlling a switching duty from the comparison signal and a first reference signal. The switching duty of the power switch 1 of the PFC circuit is controlled according to the duty control signal generated by the PFC control unit 70, so that the variations due to the internal offset be removed or reduced and a power factor of the PFC circuit be improved.

For example, referring to FIGS. 2 and/or 3, in an example, the PFC control unit 70 may include a comparison signal generation unit 71 and a comparison unit 73. The comparison signal generation unit 71 receives the output signal of the sensing and feedback signal application unit 50 and generates the comparison signal by removing or reducing the internal offset. Referring to FIG. 3, the internal offset is an input offset Vos generated by an OTA 71a in the manufacturing process.

For example, in an example, referring to FIG. 3, the comparison signal generation unit 71 may include the operational transconductance amplifier 71a and an offset removal unit 71b. The OTA 71a generates the comparison signal by receiving the output signal of the feedback signal application unit 50. The OTA 71a can generate the comparison signal in which the input offset Vos generated in the OTA is removed or reduced through the offset removal unit 71b. At this time, the offset removal unit 71b may be connected to the OTA 71a to remove or reduce the input offset Vos.

At this time, referring to FIG. 3, in an example, a positive input terminal of the OTA 71a receives the signal output from the sensing and feedback signal application unit 50, particularly the filter 53. For example, at this time, the input offset Vos of FIG. 3 is an offset generated in the OTA 71a and added to the output signal of the sensing and feedback signal application unit 50 to be a positive input of the OTA 71a.

Further, referring to FIG. 3, the offset removal unit 71b is connected to a negative input terminal of the OTA 71a. At this time, the offset removal unit 71b provides a ground signal Vss to the negative input terminal of the OTA 71a during the switching duty on D_{ON} and inputs a third reference signal V_{REF3} to the negative input terminal during the switching duty off D_{OFF}. The third reference signal _{VREF3} applied to the negative input terminal of the OTA 71a is a signal for removing or reducing the input offset Vos. In order to improve the OTA offset, by changing a negative input from the ground Vss to the third reference signal V_{REF3} during the switching duty off D_{OFF} of the PFC circuit, although there is an input offset in the OTA 71a, regulation characteristics can be maintained. For example, in FIG. 3, since the offset voltage Vos of the positive input terminal of the OTA 71a is an offset value that can occur in the OTA 71a due to changes in the manufacturing process, the offset removal unit 71b prevents abnormality of an PFC operation regardless of the occurrence of the input offset Vos in the OTA 71a.

The role of the offset removal unit 71b will be described in detail with reference to FIG. 3. For example, suppose that the offset removal unit 71b is not provided and the ground signal Vss is input to the negative input terminal of the OTA 71a. The OTA 71a operates to equalize average values of two input voltages of the negative input terminal and the positive input terminal. Since the node voltage V_{F} of the summing node N1 is V_{F}=−I_{L}Rcs during the switching duty on D_{ON} of the PFC circuit and V_{F}=−I_{L}Rcs+R(aV_{COMP}) during the switching duty off D_{OFF}, an average value of one cycle of the comparison signal input to the positive input terminal of the OTA 71a through the filter 53 of the sensing and feedback signal application unit 50 is −I_{L}Rcs+D_{OFF}R(aV_{COMP}). Therefore, the OTA 71a operates so that Vss=−I_{L}Rcs+D_{OFF}R(aV_{COMP}). By the corresponding condition, for example, when the output V_{COMP} of the feedback voltage amplification unit 31 is ‘0’, since the value of I_{L} is also ‘0’, the PFC circuit can be driven in a light load condition with a low output current. In the light load condition, the PFC circuit should be able to operate even at the I_{L} value of ‘0’ to regulate the output voltage of the PFC circuit. At this time, if the input offset Vos exists in the OTA 71a, Vss=−I_{L}Rcs+D_{OFF}R(aV_{COMP})+Vos in the OTA. In this case, even though V_{COMP} is ‘0’, since Vss=−I_{L}Rcs+Vos, I_{L}Rcs=Vos so that the input current can be ‘0’.

That is, when the input offset Vos exists in the OTA 71a without the offset removal unit 71b, the output voltage increases without being regulated in the light load condition. In order to overcome the degradation of the regulation characteristics, as in an embodiment of the present invention, the offset removal unit 71b is provided to connect the third reference signal V_{REF3} to the negative input of the OTA 71a. When connecting the third reference signal V_{REF3} like this, there is a relation: V_{REF3}=−I_{L}Rcs+D_{OFF}R(aV_{COMP})+Vos, and when V_{COMP} is ‘0’, since I_{L}Rcs=Vos−V_{REF3}, the value of I_{L} can be ‘0’.

At this time, the value of V_{REF3} may be set to the maximum value of the possible input offset Vos so that I_{L} can be 0 even at the maximum value of the possible input offset Vos. For example, in an example, the third reference signal V_{REF3} input to the negative input terminal of the OTA 71a may be set to the maximum value of the input offset that can occur in the OTA 71a.

Meanwhile, when the negative input of the OTA 71a is connected to V_{REF3}, since the value is V_{REF3}=−I_{L}Rcs+D_{OFF}R(aV_{COMP})+Vos, I_{L} can be summarized as following:

I_{L}Rcs=D_{OFF}R(aV_{COMP})+Vos−V_{REF3}

In this case, even though Vos has a value of 0, I_{L} is not proportional to V_{COMP} by V_{REF3}, If the off duty is proportional to the input voltage and the off duty and the input current I_{L} are proportional to each other, since the input voltage V_{IN} and the current I_{L} are proportional to each other, a power factor (PF) can be improved. Meanwhile, at this time, when V_{REF3} is connected to the negative input of the OTA 71a, since I_{L} is not proportional to D_{OFF}, I_{L} is not proportional to V_{IN}, resulting in a reduction in the PF.

Further, referring to FIG. 3, a second bandwidth control filter 75 may be provided on a rear end of the OTA 71a, that is, in an output terminal to adjust a bandwidth of the OTA 71a. Referring to FIG. 3, the second bandwidth control filter 75 may be an RC filter in which a resistor R2 and a capacitor C3 are connected in series. For example, the resistor R2 of the RC filter, which forms the second bandwidth control filter 75, may be connected to the rear end of the OTA 71a and the capacitor C3 may be connected to the ground. At this time, the node N3 connected to the rear end of the OTA 71a and the second bandwidth control filter 75 may be connected to a positive input terminal of the comparison unit 73. The comparison signal, which is an output voltage of the OTA 71a, that is, a node voltage I_{COMP} in the node N3 may be input to the positive input terminal of the comparison unit 73 for comparison with the first reference signal Vramp.

Continuously, referring to FIGS. 2 and/or 3, the comparison unit 73 of the PFC control unit 70 receives the comparison signal, which is an output of the comparison signal generation unit 71, and compares the comparison signal with the first reference signal Vramp to generate the duty control signal for controlling the switching duty. For example, at this time, the first reference signal Vramp operates by basically synchronizing with a CLK signal which is a fixed frequency output from an oscillator (not shown), but the first reference signal Vramp operates by synchronizing with a zero-current detection (ZCD) signal instead of the CLK signal when the inductor current I_{L} is ‘0’ before the CLK signal is generated.

Referring to FIG. 3, the PFC circuit basically performs a current conduction mode (CCM) operation. The CCM operation basically uses the CLK signal, which is the fixed frequency output from the oscillator (not shown). This signal determines a cycle in a gate voltage for driving the power switch 1 F1 of the PFC circuit to allow the CCM operation of the inductor current according to the input voltage Vin. At this time, the first reference signal Vramp input to the negative input terminal of the comparison unit 75 may be a ramp waveform signal synchronized with the CLK signal which is the fixed frequency output from the oscillator (not shown).

If the inductor current I_{L} becomes ‘0’ before the CLK signal of the fixed frequency output from the oscillator (not shown) is generated, the CCM operation can be performed using a zero-current detection (ZCD) signal generated in a ZCD block (not shown) instead of the CLK signal. That is, if the inductor current I_{L} becomes ‘0’ before the CLK signal is generated, the ZCD signal is generated. At this time, the first reference signal Vramp of FIG. 3 operates by synchronizing with the ZCD signal. Accordingly, a switching pulse is generated by the comparison unit 75 so that the CCM operation is performed by the switching operation of the power switch 1 F1. That is, if the inductor current I_{L} becomes ‘0’ before the CLK signal is generated, the first reference signal Vramp is synchronized according to the ZCD signal and the cycle of the gate voltage for operating the power switch 1 F1 of the PFC circuit is determined to enable charging and discharging of the current of the inductor 3 like a zero current.

Next, FIG. 4 will be described. FIG. 4 is a graph schematically showing a CCM operation waveform of an active PFC circuit having the PFC control circuit in accordance with an embodiment of the present invention. Meanwhile, FIG. 5 is a graph schematically showing a light load regulation waveform in an active PFC circuit having a conventional PFC control circuit. FIGS. 4 and 5 show CCM operation waveforms when an rms value Vin, rms of an input voltage is 264V, an output current lout flowing through an output load R_{L} is 500 mA, and an input offset Vos of an OTA in an IC is 10 mV. At this time, Vout is an output voltage, Iin is an input current, that is, I_{L} of FIG. 3, V_{COMP} is a fed-back output, that is, an output voltage of the feedback voltage amplification unit 31 of FIG. 3, and I_{comp} is a comparison signal voltage input to the comparator 73 of FIG. 3 to generate a duty control signal. For example, the value of YO in FIGS. 4 and 5 is the input current, that is, I_{L} of FIG. 3. Referring to FIG. 5, it can be understood that there are problems with regulation characteristics in a light load when the input offset of the OTA in the IC is large. Meanwhile, as shown in FIG. 4, in the active PFC circuit having the PFC control circuit in accordance with an embodiment of the present invention, the power factor and the OVP characteristics can be improved by applying the circuit for removing, reducing, or minimizing the OTA input offset variations in the IC in the light load and high input voltage.

FIG. 5 shows an operation waveform when the internal offset is not removed, and FIG. 4 shows an operation waveform when the internal offset is removed or reduced. For example, when there is no circuit for removing or reducing the OTA input offset Vos, if the offset Vos exists in the input of the OTA 71a, as shown in FIG. 5, the output voltage increases than a regulation level in the light load condition and the input current I_{L} cannot be ‘0’ even when the voltage V_{COMP}, that is, the fed-back and compared sensing output voltage, becomes ‘0’. Therefore, the switching operation of the PFC circuit is performed so that the output voltage is increased to reach an OVP level. Even though the output voltage is reduced to below the OVP level and the IC is operated, the above-described operation is repeated. However, when the circuit for removing or reducing the internal input offset is applied as in an embodiment of the present invention, it can be understood that the stable regulation is performed as shown in FIG. 4.

Active PFC Circuit

Next, an active PFC circuit according to a second aspect of the present invention will be described in detail with reference to the following drawings. At this time, the PFC control circuits according to the above-described embodiments of the first aspect and FIGS. 1, 2, and 4 will be referenced. Thus, repeated descriptions may be omitted.

FIG. 3 is a circuit diagram schematically showing an active PFC circuit including a PFC control circuit in accordance with an embodiment of the present invention.

Referring to FIG. 3, an active PFC circuit according to an example includes an inductor 3, a power switch 1, a diode 5, an output capacitor 7, and a PFC control circuit. For example, in an example, the active PFC circuit performs a CCM operation.

Referring to FIG. 3, the inductor 3 receives input power and transfers energy. For example, the inductor 3 receives a current from the input power, that is, an input voltage Vin output from a bridge diode 2 which full-wave rectifies AC power V_{AC}.

Next, referring to FIG. 3, the power switch 1 F1 is connected to a rear end of the inductor 3 and switched according to a duty control signal. For example, referring to FIG. 3, the power switch 1 is connected between the rear end of the inductor 3 and a ground. The power switch 1 transfers energy from the inductor 3 to an output terminal during a switching off operation. Further, the power switch 1 draws an output of the inductor 3 to the ground to block the energy transfer from the inductor 3 to the output terminal during a switching on operation. The power switch 1 is switched according to the duty control signal generated by the PFC control circuit described below. At this time, a switching duty of the power switch 1 is controlled and a power factor of the active PFC circuit can be improved. For example, the power switch 1 may be a MOSFET switch.

Referring to FIG. 3, the diode 5 of the PFC circuit is connected to the rear end of the inductor 3 in parallel to the power switch 1. The diode 5 transfers the energy output from the inductor 3 to the output terminal according to the off operation of the power switch 1. Further, the diode 5 blocks a back flow of the energy from the output terminal to the inductor 3 and the power switch 1 during the switching on operation of the power switch 1.

Next, referring to FIG. 3, the output capacitor 7 is connected to a rear end of the diode 5. That is, the output capacitor 7 is connected to the output terminal of the active PFC circuit, which is the rear end of the diode 5, in parallel to a load 9. At this time, the output capacitor 7 charges some of the energy transferred through the diode 5. Some of the energy output from the diode 5 is charged in the output capacitor 7 and the remaining energy is transmitted to the load 9. A voltage applied to both ends of the output capacitor 7 becomes an output voltage Vout of the active PFC circuit. Further, the output capacitor 7 outputs the charged energy to the load during the on operation of the power switch 1. During the on operation of the power switch 1, the energy stored in the output capacitor 7 is prevented from flowing backward to the inductor 3 and the power switch 1 by the diode 5 and all of the energy is output to the load 9 side.

Continuously, the PFC control circuit of the active PFC circuit will be described with reference to FIG. 3. At this time, the PFC control circuit generates the duty control signal by receiving the inductor current flowing in the inductor 3 and the signal sensed from the output to the load 9. The PFC control circuit is a PFC control circuit according to the above-described embodiments of the first aspect of the present invention. A matter that is not described below will refer to the descriptions of the above-described embodiments of the PFC control circuit according to the first aspect of the present invention.

For example, referring to FIG. 3, the PFC control circuit includes an inductor current sensing unit 10, an output voltage feedback unit 30, a sensing and feedback signal application unit 50, and a PFC control unit 70.

At this time, the inductor current sensing unit 10 senses the inductor current of the active PFC circuit.

Further, the output voltage feedback unit 30 outputs a feedback output signal by feeding back an output voltage sensed from the output of the active PFC circuit. For example, the output voltage feedback unit 30 may include a feedback voltage amplification unit 31 and a voltage-current conversion unit 33. Further, a first bandwidth control filter 35 may be further included to adjust a bandwidth of the feedback voltage amplification unit 31. The feedback voltage amplification unit 31 receives the output voltage, which is sensed from the output of the active PFC circuit and fed back, and a second reference signal to compare and amplify them. Further, the voltage-current conversion unit 33 receives the output of the feedback voltage amplification unit 31 and performs voltage-current conversion to output the feedback output signal.

Further, referring to FIG. 3, the sensing and feedback signal application unit 50 of the PFC control circuit outputs a sensing voltage signal or a summing signal from the output of the inductor current sensing unit 10 and the output of the output voltage feedback unit 30. For example, the sensing and feedback signal application unit 50 may output the sensing voltage signal sensed by the inductor current sensing unit 10 during switching duty on of the active PFC circuit. Further, the sensing and feedback signal application unit 50 outputs the summing signal by adding the feedback output signal to the sensing voltage signal according to the output of the inductor current sensing unit 10 during switching duty off of the active PFC circuit.

For example, referring to FIG. 3, the sensing and feedback signal application unit 50 may include a summing switch 51 and a filter 53. At this time, the summing switch 51 is turned on during the switching duty off of the active PFC circuit to generate the summing signal by adding the feedback output signal to the sensing voltage signal according to the output of the inductor current sensing unit 10. The summing switch 51 is turned off during the switching duty on of the active PFC circuit and the sensing voltage signal sensed by the inductor current sensing unit 10 is output. Further, the filter 53 filters the sensing voltage signal according to the output of the inductor current sensing unit 10 during the switching duty on of the active PFC circuit. The filter 53 receives the summing signal, which is obtained by adding the feedback output signal of the output voltage feedback unit 30 to the sensing voltage signal sensed by the inductor current sensing unit 10, and filters the summing signal. The filter 53 may output the filtered signal to provide the filtered signal to the PFC control unit 70. For example, at this time, the filter 53 may be an RC filter as shown in FIG. 3.

And, referring to FIG. 3, the PFC control unit 70 of the PFC control unit generates the duty control signal to make variations due to an internal offset be removed or reduced. At this time, the PFC control unit 70 may generate a comparison signal from the output signal of the sensing and feedback signal application unit 50 and generate the duty control signal for controlling a switching duty from the generated comparison signal and a first reference signal, so that variations due to an internal offset be removed or reduced.

For example, the PFC control unit 70 may include a comparison signal generation unit 71 and a comparison unit 73. At this time, the comparison signal generation unit 71 receives the output signal of the sensing and feedback signal application unit 50 and generates the comparison signal by removing or reducing the internal offset. For example, referring to FIG. 3, the comparison signal generation unit 71 may include an OTA 71a and an offset removal unit 71b. The OTA 71a receives the output signal of the feedback signal application unit 50 and generates the comparison signal by removing or reducing the input offset generated inside. The offset removal unit 71b may be connected to the OTA 71A to remove or reduce the input offset. For example, a positive input terminal of the OTA 71a receives the output signal of the sensing and feedback signal application unit 50. At this time, the output signal of the sensing and feedback signal application unit 50 may be added to the input offset in the OTA to be a positive input value. Further, the offset removal unit 71b may be connected to a negative input terminal of the OTA 71a to provide a ground signal to the negative input terminal during the switching duty on and input a third reference signal to the negative input terminal during the switching duty off. At this time, the third reference signal may be a signal for removing or reducing the input offset in the OTA. The third reference signal input to the negative input terminal of the OTA 71a may be set to the maximum value of the possible input offset.

Further, the comparison unit 73 receives the output of the comparison signal generation unit 71, that is, the comparison signal and compares the comparison signal with the first reference signal Vramp to generate the duty control signal for controlling a switching duty. For example, at this time, the first reference signal Vramp operates by basically synchronizing with a CLK signal which is a fixed frequency output from an oscillator (not shown), but the first reference signal Vramp operates by synchronizing with a ZCD signal instead of the CLK signal when the inductor current is ‘0’ before the CLK signal is generated.

PFC Control Method

Next, a PFC control method according to a third aspect of the present invention will be described in detail with reference to the following drawings. At this time, the PFC control circuits according to the above-described embodiments of the first aspect and FIGS. 1 to 4 will be referenced. Thus, repeated descriptions may be omitted.

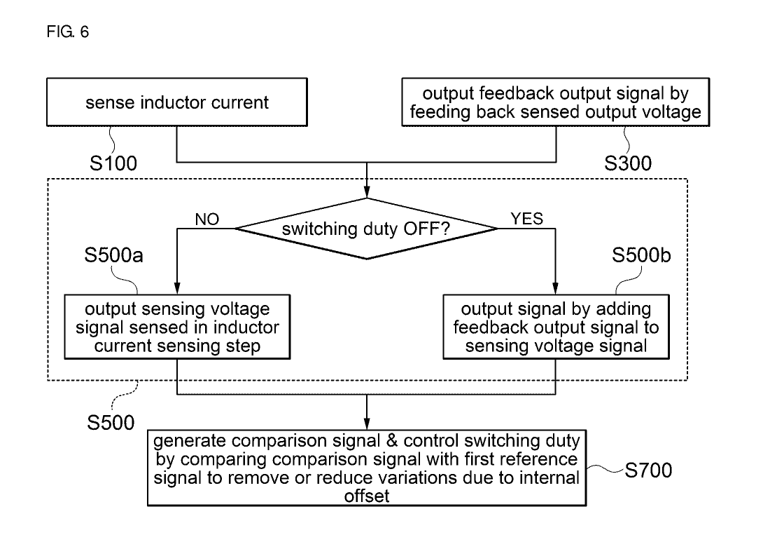

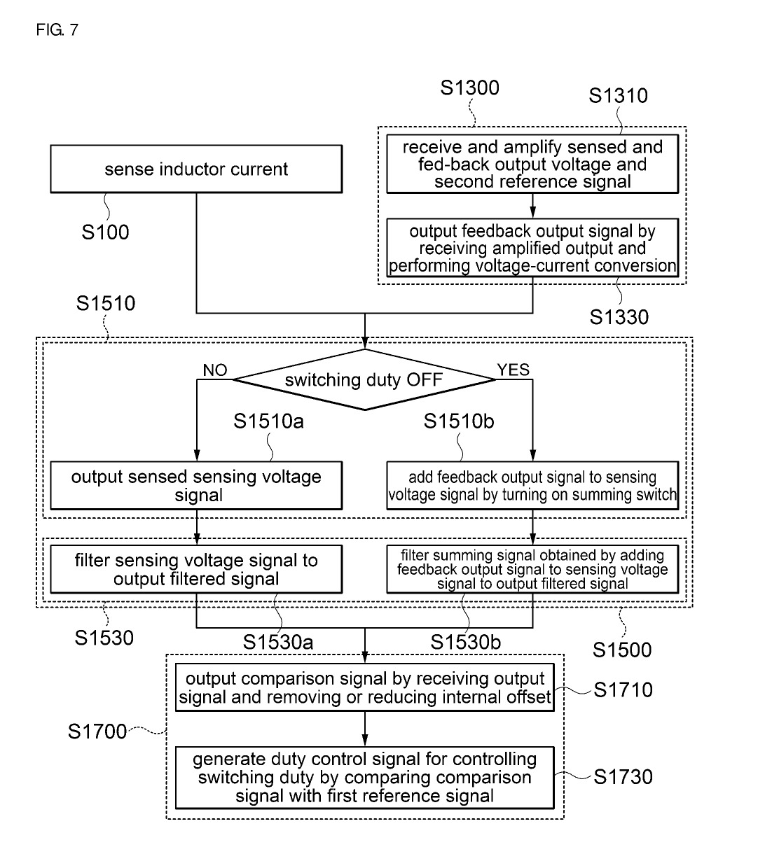

FIG. 6 is a flowchart schematically showing a PFC control method in accordance with another embodiment of the present invention, and FIG. 7 is a flowchart schematically showing a PFC control method in accordance with another embodiment of the present invention.

Referring to FIGS. 6 and 7, a PFC control method according to an example may include an inductor current sensing step S100, an output voltage feedback step S300 and S1300, a sensing and feedback signal application step S500 and S1500, and a duty control step S700 and S1700. For example, in an example, the PFC control method may be performed in a CCM-operated active PFC circuit. Each element will be described in detail.

Referring to FIGS. 6 and 7, in the inductor current generation step S100, an inductor current of a PFC circuit is sensed and output. For example, the PFC circuit may be a CCM-operated active PFC circuit.

Next, referring to FIGS. 6 and 7, in the output voltage feedback step S300 and S1300, an output voltage sensed from the output of the PFC circuit is fed back and a feedback output signal is output.

For example, referring to FIG. 7, in an example, the output voltage feedback step S1300 may include a feedback voltage amplification step S1310 and a conversion step S1330. At this time, the operation in the output voltage feedback step S1300 can be understood with reference to the operation of an output voltage feedback unit 30 of FIG. 3. Referring to FIGS. 3 and 7, in the feedback voltage amplification step S1310, a feedback voltage amplification unit 31 receives an output voltage, which is sensed from the output of the PFC circuit and fed back, and a second reference signal to compare and amplify them. Further, referring to FIGS. 3 and 7, in the conversion step S1330, a voltage-current conversion unit 33 receives the output of the feedback voltage amplification step S1310 and performs voltage-current conversion to output the feedback output signal.

Next, referring to FIGS. 6 and 7, in the sensing and feedback signal application step S500 and S1500, a sensing voltage signal is output by receiving the output of the inductor current sensing step S100 during switching duty on of the PFC circuit. Further, in the sensing and feedback signal application step S500 and S1500, a signal obtained by adding the feedback output signal to the sensing voltage signal is output during switching duty off of the PFC circuit. At this time, the feedback output signal is a signal output in the output voltage feedback step S300 and S1300.

For example, referring to FIG. 7, the sensing and feedback signal application step S1500 may include a signal summing step S1510 and S1510b and a filtering step S1530. At this time, the operation in the sensing and feedback signal application step S1500 can be described with reference to the operation of a sensing and feedback signal application unit 50. Referring to FIG. 7, in the signal summing step S1510 and S1510b, a summing switch 51 is turned on to add the feedback output signal to the sensing voltage signal during the switching duty off. At this time, the summing switch 51 is turned off during the switching duty on and the sensing voltage signal obtained from the inductor current sensing step S100 is output S1510a. Next, in the filtering step S1530 of FIG. 7, for example, a filter 53 of FIG. 3 filters the sensing voltage signal during the switching duty on S1530a. Further, a summing signal obtained by adding the feedback output signal to the sensing voltage signal is filtered during the switching duty off S1530b. The filtered signal is provided to the next comparison signal generation step S500 and S1500 for generation of a comparison signal.

Next, referring to FIGS. 6 and 7, in the duty control step S700 and S1700, in order to make variations due to an internal offset be removed or reduced, the comparison signal is generated from the output of the sensing and feedback signal application step S500 and S1500 and a duty control signal for controlling a switching duty is generated from the comparison signal and a first reference signal. A switching duty of a power switch 1 can be controlled according to the duty control signal generated in the duty control step S700 and S1700.

For example, referring to FIG. 7, the duty control step S1700 may include a comparison signal generation step S1710 and a control signal generation step S1730. The operation of the duty control step S1700 can be understood with reference to the operation of a PFC control unit 70 of FIG. 3. Referring to FIG. 7, in the comparison signal generation step S1710, for example, a comparison signal generation unit 71 of FIG. 3 receives the output signal of the sensing and feedback signal application unit 50 and outputs the comparison signal by removing or reducing the internal offset. At this time, referring to FIG. 3, in an example, in the comparison signal generation step S1710, the output signal in the sensing and feedback signal application step S500 and S1510 is input to a positive input terminal of an OTA 71a, ground power is input to a negative input terminal of the OTA 71a during the switching duty on, and a third reference signal V_{REF3} is input to the negative input terminal of the OTA 71a during the switching duty off. At this time, the OTA 71a may output the comparison signal by removing or reducing the internal input offset. For example, at this time, the third reference signal V_{REF3} input to the negative input terminal may be set to the maximum value of the possible input offset.

Further, in the control signal generation step S1730 of FIG. 7, the duty control signal for controlling a switching duty is generated by receiving the comparison signal, that is, the output of the comparison signal generation step S1710 and comparing the comparison signal with the first reference signal.

As described above, in an embodiment of the present invention, it is possible to improve the power factor and the OVP characteristics by applying the circuit for removing, reducing, or minimizing the variations due to the input offset of the OTA 71a in the IC in the light load and high input voltage conditions.

According to an embodiment of the present invention, it is possible to improve a power factor during a PFC operation of a PFC circuit. For example, it is possible to improve a power factor and OVP characteristics by implementing a circuit for minimizing OTA input offset variations in an IC.

Further, in an embodiment of the present invention, it is possible to improve a power factor and OVP characteristics by applying a circuit for minimizing OTA input offset variations in an IC in light load and high input voltage conditions to overcome the problems of a conventional CCM PFC circuit.

It is apparent that various effects which have not been directly mentioned according to the various embodiments of the present invention can be derived by those skilled in the art from various constructions according to the embodiments of the present invention.

The above-described embodiments and the accompanying drawings are provided as examples to help understanding of those skilled in the art, not limiting the scope of the present invention. Further, embodiments according to various combinations of the above-described components will be apparently implemented from the foregoing specific descriptions by those skilled in the art. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

What is claimed is:

1. A PFC control circuit comprising:
an inductor current sensing unit for sensing an inductor current of a PFC circuit;
an output voltage feedback unit for outputting a feedback output signal by feeding back an output voltage sensed from an output of the PFC circuit;
a sensing and feedback signal application unit for outputting a sensing voltage signal sensed by the inductor current sensing unit during switching duty on of the PFC circuit and outputting a signal obtained by adding the feedback output signal to the sensing voltage signal during switching duty off of the PFC circuit; and
a PFC control unit for generating a comparison signal from an output of the sensing and feedback signal application unit and generating and outputting a duty control signal for controlling a switching duty from the comparison signal and a first reference signal to make variations due to an internal offset be removed or reduced.

2. The PFC control circuit according to claim 1, wherein the sensing and feedback signal application unit comprises:
a summing switch turned on during the switching duty off to add the feedback output signal to the sensing voltage signal; and
a filter for receiving the sensing voltage signal or a summing signal, which is obtained by adding the feedback output signal to the sensing voltage signal, and filtering the received signal to output the filtered signal.

3. The PFC control circuit according to claim 1, wherein the output voltage feedback unit comprises:
a feedback voltage amplification unit for receiving the output voltage, which is sensed from the output of the PFC circuit and fed back, and a second reference signal to compare and amplify the received voltage and signal; and
a voltage-current conversion unit for receiving an output of the feedback voltage amplification unit and performing voltage-current conversion to output the feedback output signal.

4. The PFC control circuit according to claim 1, wherein the PFC control unit comprises:
a comparison signal generation unit for receiving the output signal of the sensing and feedback signal application unit and outputting the comparison signal by removing or reducing the internal offset; and
a comparison unit for receiving the comparison signal and comparing the comparison signal with the first reference signal to generate the duty control signal for controlling a switching duty.

5. The PFC control circuit according to claim 4, wherein the comparison signal generation unit comprises:
an OTA for receiving the output signal of the sensing and feedback signal application unit and outputting the comparison signal in which the input offset generated inside is removed or reduced; and
an offset removal unit connected to the OTA to remove or reduce the input offset.

6. The PFC control circuit according to claim 5, wherein a positive input terminal of the OTA receives the output signal of the sensing and feedback signal application unit, and the offset removal unit is connected to a negative input terminal of the OTA to provide a ground signal to the negative input terminal during the switching duty on and input a third reference signal to the negative input terminal during the switching duty off.

7. The PFC control circuit according to claim 6, wherein the third reference signal input to the negative input terminal is set to the maximum value of the possible input offset.

8. The PFC control circuit according to claim 1, wherein the PFC circuit is a CCM-operated active PFC circuit.

9. An active PFC circuit comprising:
an inductor for receiving input power to transfer energy;
a power switch connected to a rear end of the inductor to transfer the energy from the inductor to an output terminal during a switching off operation and block the transfer of the energy to the output terminal during a switching on operation according to a duty control signal;
a diode connected to the rear end of the inductor in parallel to the power switch to transfer the energy to the output terminal and block a backflow of the energy from the output terminal during the switching on operation of the power switch;
an output capacitor connected to the output terminal, which is a rear end of the diode, in parallel to a load to charge some of the energy transferred through the diode and output the charged energy to the load during the on operation of the power switch; and
a PFC control circuit according to claim 1, which generates the duty control signal by receiving an inductor current flowing in the inductor and a signal sensed from an output to the load.

10. The active PFC circuit according to claim 9, wherein a PFC control unit of the PFC control circuit comprises:
a comparison signal generation unit for receiving an output signal of a sensing and feedback signal application unit and outputting a comparison signal by removing or reducing an internal offset; and
a comparison unit for generating the duty control signal for controlling a switching duty by receiving the comparison signal and comparing the comparison signal with a first reference signal.

11. The active PFC circuit according to claim 10, wherein the comparison signal generation unit comprises:
an OTA for receiving the output signal of the sensing and feedback signal application unit and outputting the comparison signal in which the input offset generated inside is removed or reduced; and
an offset removal unit connected to the OTA to remove or reduce the input offset,
wherein a positive input terminal of the OTA receives the output signal of the sensing and feedback signal application unit, and
the offset removal unit is connected to a negative input terminal of the OTA to provide a ground signal to the negative input terminal during switching duty on and input a third reference signal to the negative input terminal during switching duty off.

12. The active PFC circuit according to claim 11, wherein the third reference signal input to the negative input terminal is set to the maximum value of the possible input offset.

13. The active PFC circuit according to claim 9, wherein the active PFC circuit performs a CCM operation.

14. A PFC control method comprising:
an inductor current sensing step of sensing an inductor current of a PFC circuit;
an output voltage feedback step of outputting a feedback output signal by feeding back an output voltage sensed from an output of the PFC circuit;
a sensing and feedback signal application step of outputting a sensing voltage signal sensed in the inductor current sensing step during switching duty on of the PFC circuit and outputting a signal obtained by adding the feedback output signal to the sensing voltage signal during switching duty off of the PFC circuit; and
a duty control step of generating a comparison signal from an output of the sensing and feedback signal application step and generating and outputting a duty control signal for controlling a switching duty from the comparison signal and a first reference signal to make variations due to an internal offset be removed or reduced.

15. The PFC control method according to claim 14, wherein the sensing and feedback signal application step comprises:
a step of adding the feedback output signal to the sensing voltage signal by turning on a summing switch during the switching duty off; and
a filtering step of filtering the sensing voltage signal during the switching duty on and filtering a summing signal, which is obtained by adding the feedback output signal to the sensing voltage signal, to output the filtered signal during the switching duty off.

16. The PFC control method according to claim 14, wherein the output voltage feedback step comprises:
a feedback voltage amplification step of receiving an output voltage, which is sensed from the output of the PFC circuit and fed back, and a second reference signal to compare and amplify the received voltage and signal; and
a conversion step of receiving an output of the feedback voltage amplification step and performing voltage-current conversion to output the feedback output signal.

17. The PFC control method according to claim 14, wherein the duty control step comprises:
a comparison signal generation step of receiving the output signal of the sensing and feedback signal application step and outputting the comparison signal by removing or reducing the internal offset; and
a control signal generation step of generating the duty control signal for controlling a switching duty by receiving the comparison signal and comparing the comparison signal with the first reference signal.

18. The PFC control method according to claim 17, wherein in the comparison signal generation step, the signal applied from the sensing and feedback signal application step is input to a positive input terminal of an OTA,
ground power is input to a negative input terminal of the OTA during the switching duty on and a third reference signal is input to the negative input terminal of the OTA during the switching duty off, and
the OTA outputs the comparison signal by removing or reducing the internal input offset.

19. The PFC control method according to claim 18, wherein the third reference signal input to the negative input terminal is set to the maximum value of the possible input offset.

20. The PFC control method according to claim 14, wherein the PFC circuit is a CCM-operated active PFC circuit.
